(19) United States
(12) Patent Application Publication
(10) Pub. No.: US 2006/0285338 A1
(43) Pub. Date: Dec. 21, 2006

(54) METHOD OF BASE ATTACHMENT TO ELECTRIC LAMP BY MAGNETIC FORMING

(75) Inventor: Klaus Eberhard MEINECKE, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 11/459,139

(22) Filed: Jul. 21, 2006

Related U.S. Application Data
(62) Division of application No. 10/504,748, filed on Aug. 17, 2004.

(30) Foreign Application Priority Data
Feb. 20, 2002 (DE) 102 07 063.6

(51) Int. Cl. F21V 19/00

(52) U.S. Cl. 362/382

(57) ABSTRACT

A method of manufacture of a base attachment for electric lamps and of electric lamps having the base attachment. A base is attached to a cylindrical lamp neck by deforming an area of the base by magnetic forming and engaging the area with a recess in the lamp bulb. An electric lamp with an uncemented base attachment is manufactured easily and efficiently.

The invention relates to a base attachment on electric lamps, which attaches a base to a cylindrical lamp neck by means of mutual engagement.

Such a base attachment is known, for example, from JP 55131949. With this arrangement, in one point the base of an electric lamp is attached to the cylindrical lamp neck thereof by mutual engagement. The cylindrical lamp neck, which consists of borosilicate glass or another hard glass, has an indentation on its surface in the area of transition to the lamp bulb. A part of the metallic screw base is forced mechanically into this indentation, such that an interlocking connection of these two parts is produced. This mechanical deformation of the base rim is effected by pressing or forcing a ram tool against the lamp base, which is cylindrical in this area. The above-mentioned arrangement is very complex to manufacture on a highly automated mass production basis, if such production is possible at all, since, inter alia, additional positioning of the lamp neck with the indentation is necessary in order to reliably achieve the desired action of the ram tool. Despite a long-standing need for such an arrangement, the proposed procedure for a so-called “uncemented” lamp attachment has proved impossible to accomplish in practice.

On the other hand, the magnetic forming method has long been known, for example from U.S. Pat. No. 3,251,974. With this method, which is a high speed production process, forces are generated by rapidly changing magnetic fields, which forces are used for non-contact forming of in particular thin metal parts exhibiting good electrical conductivity, which metal parts consist of aluminum or copper for example. Within a few microseconds, a strong magnetic field is built up by the current flow in a coil, whereby a current is induced in a workpiece. This current and the magnetic flux density of the field determine the force which becomes active between workpiece and working coil. If, for example, a thin, cylindrical body is to be forced externally onto another cylindrical body, which regularly exhibits play in relation thereto, “compression coil systems” are used. Previous industrial applications of the above-described magnetic forming relate in particular to the deforming connection of two metallic tubes, also by means of a collar, or connection of a tube to a fitting. Industrial applications of magnetic forming which may in particular be used in the context of mass production of lamps are not known.

It is an object of the invention to provide a base attachment for electric lamps and an electric lamp with such a base attachment, which may be produced partially or fully automatically, technologically simply and cost-effectively, and where the quality of the attachment satisfies to usual loading and safety requirements.

The object of the invention is achieved in that the mutual engagement is brought about between at least one deformed area of the base produced by magnetic forming and at least one recess in the lamp bulb.

According to the invention, the particular manner of applying the magnetic forming method has to be adapted to the lamp type used in each case. The main magnetic forming parameters, such as the induced current, the pulse intensity and the magnetic flux density of the field, which determine the force generated, are of particular significance in this instance. The connection strength conventionally required must be ensured without impairing the performance of the lamp. In the case of a lamp with a screw base, the attachment must in certain cases be capable of withstanding, for example, a torsional force of 2.5 Nm. In addition, the material used and the dimensioning of the lamp base, in particular the wall thickness of the base, must routinely be taken into account. The shape and number of recesses in the lamp bulb must be adjusted as a function of the required connection strength, in such a way that reliable performance of the lamp is ensured. The material parameters of the lamp neck, regularly produced from borosilicate glass or another conventional soft or hard glass or quartz, have also to be given due consideration, especially in order to reliably avoid damage thereto.

Preferred materials for the base, at least for the areas which are purposefully deformed by magnetic forming, are ductile materials with good electrical conductivity, such as aluminum, copper or alloys thereof.

The recess is preferably convex in shape and has rounded areas of transition to the adjoining areas of the bulb. This shape or form of the recess and the adjoining areas allows technologically simple production of the lamp neck.

A further preferred configuration of the invention relates to a special arrangement of the power supply system. One end of at least one conventional power supply lead is arranged between base and bulb, such that the latter is connected in electrically conductive manner to the base after magnetic forming. Additional attachment, for example by conventional soldering, is not necessary with a power supply lead, thus arranged such that lamp production efficiency is further increased by the base attachment according to the invention.

The object of the invention is additionally achieved by the provision of a lamp which comprises at least one base attachment according to the features of the claims 1 to 4. The production and hense provision of lamps which have a so-called “uncemented” base attachment are a focal point of development and are of enormous economic significance. Such arrangements have to fulfill the considerable demands of partially or fully automated industrial manufacture, for example with regard to the quality required of the lamps produced, the use of maximally environmentally compatible means and short cycle times, if they are to be applied in practice.

The invention will be described with reference to an embodiment shown in the drawings to which, however, the invention is not restricted. In the Figures:

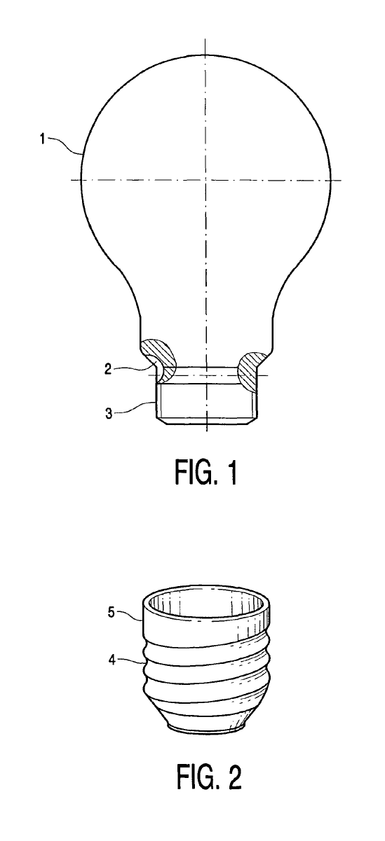

FIG. 1 is a side, partially exploded view of the bulb of a lamp with a screw base, and

FIG. 2 is a schematic representation of a base.

FIG. 1 shows a lamp bulb 1, which has recesses 2 in the area of transition to the cylindrical lamp neck 3. The recesses 2, of which only one is visible in FIG. 1, are each convex in shape and exhibit rounded areas of transition to the adjoining areas of the bulb. The bulb 2 is made from a soft glass.

A base 4, made of aluminum, is shown in FIG. 2. In the upper part of the base 4, which in the assembled state is directed towards the lamp bulb 1, there is arranged a cylindrical area 5, which is forced against the cylindrical lamp neck 3 during magnetic forming. The lower part of the base 4 is provided with a conventional screw base thread.

1-5. (canceled)

6. A method of joining a base to a lamp neck of an electric lamp bulb by means of mutual engagement, the method comprising the acts of:
forming the lamp neck to have a recess;
deforming an area of the base magnetically to engage the recess.

7. The method of claim 6, comprising the act of forming the base from a ductile material with electrical conductivity that is suitable for the electric lamp.

8. The method of claim 7, wherein the act of forming the base comprises the act of forming the base from one of aluminum, copper, aluminum alloy or copper alloy.

9. The method of claim 6, wherein the act of forming the lamp neck to have the recess comprises the act of forming the recess to be convex in shape.

10. The method of claim 9, wherein the act of forming the recess to be convex in shape comprises the act of forming the recess to exhibit a rounded area of transition to an adjoining area of the bulb.

11. The method of claim 6, comprising the act of arranging fixedly a power supply lead between the base and the bulb.

12. The method of claim 6, comprising the act of adapting the magnetic deforming to a particular lamp type.

13. The method of claim 6, comprising the act of adapting the forming and deforming to be able to withstand a torsional force of substantially 2.5 Nm.

14. The method of claim 13, wherein the act of forming the lamp neck to have the recess comprises the act of forming the lamp neck to have a plurality of recesses, and wherein the act of deforming an area of the base comprises the act of deforming a plurality of areas of the base by magnetically deforming the base to engage the plurality of recesses of the bulb.

15. A method of joining a base to a lamp neck of an electric lamp bulb by means of mutual engagement, the method comprising the acts of:
forming the lamp neck to have at least one recess;
engaging the at least one recess of the bulb to at least one area of the base by magnetically deforming the base.

16. The method of claim 15, wherein the act of forming the lamp neck to have the at least one recess comprises the act of forming the at least one recess to be convex in shape.

17. The method of claim 15, wherein the act of forming the at least one recess to be convex in shape comprises the act of forming the at least one recess to exhibit a rounded area of transition to at least one adjoining area of the bulb.

18. A method of manufacturing a lamp, the method comprising:
forming a lamp bulb to have one or more recesses;
deforming an area of a lamp base magnetically; and
engaging a one of the one or more recesses of the lamp bulb and the lamp base.

19. The method of claim 18, wherein the act of forming the lamp bulb to have the one or more recesses comprises the act of forming a lamp neck to have a plurality of recesses, and wherein the act of deforming an area of the lamp base comprises the act of deforming a plurality of areas of the lamp base by magnetically deforming the lamp base to engage the plurality of recesses of the lamp bulb.

20. The method of claim 18, wherein the act of engaging a one of the one or more recesses of the lamp bulb and the lamp base comprises the act of forcing a cylindrical area of the lamp base against a cylindrical lamp neck of the lamp bulb.
